(19) United States
(12) Patent Application Publication
(10) Pub. No.: US 2003/0026246 A1
(43) Pub. Date: Feb. 6, 2003

(54) Cached IP routing tree for longest prefix search

(75) Inventors: James Huang, Irvine, CA (US); Eric Lin, Hacienda Heights, CA (US); Steven Hsieh, Laguna Hills, CA (US); James Yik, Mission Viejo, CA (US); Ilya Dorfman, Irvine, CA (US); George Cravens, Laguna Hills, CA (US)

Correspondence Address: ARTER & HADDEN, LLP, 1100 HUNTINGTON BUILDING, 925 EUCLID AVENUE, CLEVELAND, OH, 44115-1475, US

(73) Assignee: Zarlink Semiconductor V.N. Inc., Irvine, CA

(21) Appl. No.: 10/163,478

(22) Filed: Jun. 5, 2002

Related U.S. Application Data
(60) Provisional application No. 60/296,342, filed on Jun. 6, 2001.

(51) Int. Cl. H04L 12/66

(52) U.S. Cl. 370/352; 370/401

(57) ABSTRACT

Architecture for processing routing information in a data network. A set of routing information entries is provided in a routing database of a first storage location. A subset of the routing information entries is created in a second storage location, which subset of the routing information entries are in the structure of an IP tree. Packet routing information of an incoming packet is extracted, which packet routing information includes multiple byte parts. The second storage location is accessed to compare the multiple byte parts of the packet routing information sequentially with respective entries of the subset of routing information entries to determine forwarding information. The subset of routing information in the second location is adjusted dynamically in response to the availability of the packet routing information in the subset of routing information entries.

### BACKGROUND OF THE INVENTION

This application claims priority under 35 U.S.C. 119(e) from U.S. Provisional patent application Serial No. 60/296,342 entitled “Cached IP Routing Tree For Longest Prefix Search” and filed Jun. 6, 2001.

This invention is related to routing tree search engines, and more particularly to a cached IP routing tree searching for the longest prefixes.

With the Internet becoming increasingly the network of choice for performing a wide variety of functions, the need for locating a destination node in a short period of time is becoming paramount. Network nodes are uniquely identifiable utilizing IP addressing. Interrogating an IP address takes time in the process of routing data to its appropriate destination. Real-world data relay performance is often limited by the size of the routing table, which can be a major problem when scaling to larger internetworks. Various methods have been implemented in an effort to minimize the time to route data through the maze of networks which comprise the Internet, and other global communication networks. Some such methods utilize a look-up table of all known addresses, which table requires an inordinate hardware outlay (e.g., high speed memory) to support high-speed look-ups for a large number of table entries. With the growing number of IP addresses being utilized, and the implementation of additional domain name designators to satisfy this demand for addresses, the use of such tables becomes highly problematic. One of the ways to maintain the routing table at a reasonable size is through the use of hierarchical addressing structures and the tree organizations they make possible. However, such trees can still provide an obstacle to high speed data forwarding in the gigabit networks being considered to ease data traffic congestion.

What is needed is an IP routing tree search architecture which minimizes the time required to route a data packet it to the appropriate destination node.

### SUMMARY OF THE INVENTION

The present invention disclosed and claimed herein, in one aspect thereof, comprises architecture for processing routing information in a data network. A set of routing information entries is provided in a routing database of a first storage location. A subset of the routing information entries is created in a second storage location, which subset of the routing information entries are in the structure of an IP tree. Packet routing information of an incoming packet is extracted, which packet routing information includes multiple byte parts. The second storage location is accessed to compare the multiple byte parts of the packet routing information sequentially with respective entries of the subset of routing information entries to determine forwarding information. The subset of routing information in the second location is adjusted dynamically in response to the availability of the packet routing information in the subset of routing information entries.

### BRIEF DESCRIPTION OF THE DRAWINGS

For a more complete understanding of the present invention and the advantages thereof, reference is now made to the following description taken in conjunction with the accompanying drawings in which:

FIG. 1 illustrates a general block diagram of the component blocks, in accordance with the invention;

FIG. 2 illustrates a flow diagram of packet processing, in accordance with a disclosed embodiment;

FIG. 3 illustrates a flow diagram for address resolution where the maximum search distance is four levels, according to a disclosed embodiment;

FIG. 4 illustrates a backtrack scenario, in accordance with a disclosed embodiment;

FIG. 5 illustrates a flow diagram in accordance with an algorithm code;

FIG. 6 illustrates a node control block (IPCT) structure;

FIG. 7 illustrates a structure for the PSDE;

FIG. 8 illustrates a structure diagram of a route pending entry;

FIG. 9 illustrates a sample PSDE reference list data structure;

FIG. 10 illustrates a general diagram of a routing tree, in accordance with a disclosed embodiment;

FIG. 11 illustrates a first example routing tree utilizing a software routing table;

FIG. 12 illustrates a resulting routing tree when continuing with packet processing according to the routing tree of FIG. 11;

FIG. 13 illustrates a second example of the creation of a routing tree;

FIG. 14 illustrates an updated cached routing tree that includes an updated leaf node that replaces the leaf node of the routing tree of FIG. 13;

FIG. 15 illustrates an updated routing tree from the example of FIG. 14;

FIG. 16 illustrates an example routing tree when the software manager sends two Route Add messages;

FIG. 17 illustrates a fourth example of creating a cached routing tree when a table entry is deleted in the routing database;

FIG. 18 illustrates a revised routing tree in accordance with the deleted routing table entry of FIG. 17;

FIG. 19 illustrates an updated cached routing tree as a result of further entries being deleted in the routing table of the routing database;

FIG. 20 illustrates a revised cached routing tree where still further table entries are deleted in the routing table of the routing database;

FIG. 21 illustrates a fifth example of creating a cached routing tree when a table entry is deleted in the routing database;

FIG. 22 illustrates an updated routing tree of the tree of FIG. 21, when a table entry is deleted;

FIG. 23 illustrates an example of updating a cached routing tree when a node is aged out; and

FIG. 24 illustrates an example routing tree created where a routing table of the routing database includes a directly attached entry.

### DETAILED DESCRIPTION OF THE INVENTION

The disclosed architecture implements a longest prefix match IP (Internet Protocol) routing tree search in hardware in bounded steps (at most four steps) with limited hardware memory.

A major difference between the disclosed architecture and conventional algorithms is that the routing tree of the disclosed architecture does not contain all of the routing information. The routing tree is built “on demand” when the routing engine encounters a packet with unresolved routing information. With dynamic adjustment of the routing tree in hardware, only a small memory configuration is needed to support a large number of routes.

A control central processing unit (CPU) (either local or remote) contains a full set of routing entries in a routing database, with access controlled by a software manager, and therefore the routing switch hardware need only cache a subset of the full set of routing entries. The subset of routing entries are dynamically added and purged in the memory on an on-demand basis.

The disclosed algorithm can be categorized as a type of multi-way fixed-stride tree. In this algorithm, a 32-bit IP address is divided into four 8-bit parts (or bytes) such that a prefix match is first performed on the first eight bits. If no route is found based upon the first 8-bit part, the next eight bits are used, and so on. In the worst case, the process is repeated for all thirty-two bits, or four times, since there are four 8-bit parts.

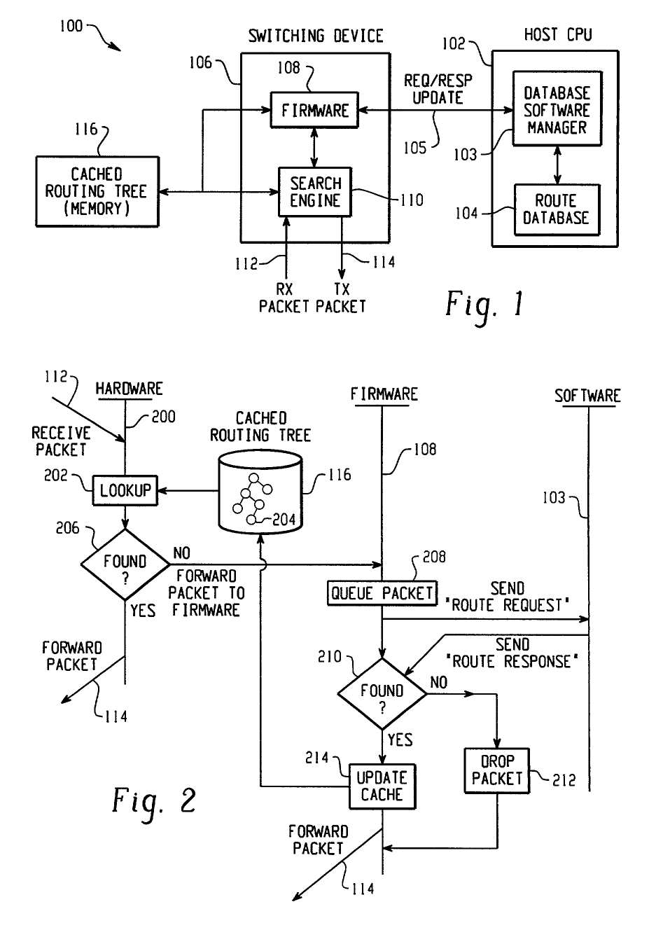

Referring now to FIG. 1, there is illustrated a general system block diagram of the primary component blocks, in accordance with a disclosed embodiment. The implementation comprises two principal components: a first software component that comprises a software manager for managing the entire routing database of routing table entries; and a second firmware/hardware-based component that comprises the switching device and a cached memory, which cache memory stores a routing tree that is a subset of the routing entries in the routing database. The second component can be divided further into two sub-components: a firmware sub-component that includes an interface algorithm for maintaining the cached routing tree; and a hardware sub-component that performs the routing tree search and packet forwarding.

Thus there is provided a switching system 100 suitably configured according to the disclosed architecture to include a host CPU 102 that contains a routing database software manager 103 that maintains a full set of routing entries in a routing database 104. Database routing entries of the routing database 102 are passed over a Request/Response update communication path 105 to a switching device 106 on an as-needed basis. The switching device 106 contains a firmware 108 that, among other things, communicates the Request/Response signals to the CPU 102 in order to retrieve the desired entries. The switching device 106 also includes a search engine 110 for performing the search based upon a packet that is received via a receive port 112 and transmitted, once the correct destination route is determined, over a transmit port 114. The search engine 110 is in communication with the firmware 108 for passing routing entry information therebetween, that was received from the software manager 103 when a routing entry was not available first, in the cached routing tree. Both the firmware 108 and the search engine 110 are in communication with a cache memory 116, which cache memory 116 stores a subset of the routing table entries in the form of routing tree information for high speed access by the search engine 110 during the search being performed. The firmware 108 is responsible for creating and maintaining the cached routing tree in the cache memory 116. The routing tree is set to a known null state during initializaion.

When the search engine 110 interrogates a received packet, it extracts the destination address, and accesses an IP tree of routing entries in the cache memory 116 for suitable routing information. If the routing information is not available in the cache memory 116, the search engine 110 signals the firmware 108 of the need for further routing information related to the packet that was received. The firmware 108 then accesses the routing database software manager 103, which attempts to retrieve the appropriate routing information from the routing database 104, and if successful, sends the routing information back to the cache memory 116. Of course, the firmware 108 could also pass the routing information directly to the search engine 110 to reduce the wait time of the search in progress, and then pass it to the cache memory 116 for storing, and use on a subsequent search. Referring now to FIG. 2, there is illustrated a flow diagram of packet processing, in accordance with a disclosed embodiment. Software components that maintain the entire routing database 104 are responsible for communicating with other routers of the network utilizing conventional routing protocols to obtain route information. Such conventional routing protocols running at this level include, but are not limited to, RIP (Routing Information Protocol), OSPF (Open Shortest Path First), and BGP (Border Gateway Protocol). Static routes can also be defined.

In operation, when a packet is received into the switching device 106 via the packet receive port 112, the packet destination address is extracted, and the hardware 200 of the switching device 106 performs a lookup operation, as denoted by a lookup function block 202. In order to provide fast resolution of the packet destination address, the cache memory 116 includes a cached routing tree 204. The lookup function block 202 accesses the fast cache memory 116 first, to extract relevant routing information from the routing tree 204, if available. Flow is then to a decision block 206 to determine the next path to take depending on the availability of the routing information in the cached routing tree 204. If the routing information is found in the cached routing tree 204, flow is out the “Yes” path to then forward the packet along the transmit path 114 to the next destination.

If the routing information associated with the packet destination address is not found in the cached routing tree 204, flow is out the “No” path of decision block 206 to the firmware 108 where the packet is forwarded to a packet queue 208. The firmware 108 interrogates the packet, and sends a “Route Request” message to the routing database software manager 103 of the host CPU 102. The software manager 103 accesses the routing database 104 to retrieve routing information relevant to the destination information included in the packet, and sends a “Route Response” message back to the firmware 108.

In a decision block 210, the firmware 108 determines from the Route Response message whether the routing information for that packet was available in the routing database 104. If not, flow is out the “No” path to a function block 212 where the packet is dropped. Flow is then back to the firmware 108 to process the next incoming packet. If the routing information for the packet was found in the routing database 104, flow is out the “Yes” path of decision block 210 to a function block 214 to update the cached routing tree 204. Additionally, flow is then from the function block 214 to forward the packet out the transmit path 114. Note that the search engine 110 is optimized for look-up speed, and thus only does lookup of the routing tree 204. The search engine 110 is not burdened with updating the cached routing tree 204.

Three different events will cause the routing tree 204 to change. A first event, as indicated previously, is when a packet is received by the search engine 110 (hardware) and destination routing information is not found in the cached routing tree 204. The firmware 108 will queue up the packet for later processing, and send the “Route Request” message to the software manager 103 to search the routing table of the routing database 104 for the associated routing information. After searching the routing database 104, the software manager 103 sends the “Route Response” message to the firmware 108. If the routing information does exist in the routing database 104, the queued packet is forwarded according to the retrieved routing information, and the cached routing tree 204 is updated. If the routing information does not exist in the routing database 104, the queued packet is dropped.

A second event that will cause a change in the cached routing tree 204 is a cached route timeout. When a route is not being accessed for a period of time, the hardware 200 will notify the firmware 108 to remove the routing information from the cached routing tree 204, via a process called aging.

A third event that will cause a change in the cached routing tree 204 is updating of the routing information from the routing database 104. When routing information is changed, the software manager 103 notifies the firmware 108 to update the routing information in the cached routing tree 204. If routing information associated with the updated routing information already exists in the cached routing tree 204, the existing routing information is updated. Otherwise, the firmware 108 will ignore the update message.

One of the advantages of the disclosed IP addressing scheme is that it is hierarchical, which allows the address search process to be deterministic. In this way, it can be determined exactly what the minimum performance will be regardless of address behavior. The address resolution scheme used for IP addresses consists of up to four layers of direct-addressed pointer tables, each addressed by using one of the bytes of the IP address as an offset index. These tables are accessed sequentially, that is, always starting with the most significant byte (i.e., leftmost byte). The first table can be implemented in internal high-speed memory, e.g., SRAM, for single-tic access, but may not have to be, as it only saves three tics per packet.

The forwarding algorithm resolves the destination IP address using a longest-prefix matching scheme to get a pointer to a Protocol Switching Database Entry (PSDE). The PSDE contains the destination port number, next hop VLAN ID, and the next hop destination MAC (Media Access Control) address. All of the information needed to forward the packet is contained in the PSDE.

The PSDE may point to either another router (Next_Hop_Router) or a “direct attached” node (i.e., one with no intervening routers (ARP_Mapping, i.e., Address Resolution Protocol Mapping)). In either case, the packet processing is the same, since the same information is needed from the PSDE. There will likely be many addresses that resolve down to a single next-hop router, but only one PSDE is needed per next-hop router. However, each direct-attached node must have its own PSDE, since each node has a unique MAC Address.

Once the PSDE has been found, a switch response formatter needs to compare the destination VLAN ID to the source VLAN ID. If they match, the packet is forwarded, and a message will be sent for ICMP (Internet Control Message Protocol) route-redirect. If the source port is the same as the destination port, the packet is dropped and a message is sent, unless the source VLAN ID is different from the destination VLAN ID. The next hop encapsulation type (from the PSDE) will be compared with the switch request field, and if they differ, the packet is forwarded for further processing (the hardware cannot convert packet encapsulation).

If address resolution fails (i.e., no valid PSDE is found), a Route Request message is sent to the software manager 103 of the CPU 102. A small number of packets are queued up while address resolution is pending, but once the number of pending packets hits a predetermined limit, further packets will be dropped until address resolution is complete. Once the software manager 103 sends a Route Response from the CPU 102, switch response messages are generated for the pending packets, and a PSDE is formatted and entered into the address database 104 to enable hardware to forward further packets.

The system is capable of maintaining simple IP statistics, if enabled (default should be “IP Statistics disabled”). This is done by using eight bytes of the PSDE so that hardware can keep count of the number of TX Packets (four bytes) and Dropped Packets (four bytes). The packet counters are thirty-two bits each. When any of these packet counters rollover, a message is sent with the IP address, and a two-bit field indicating which counter rolled. The PSDE entry is simply allowed to rollover and keep counting, and the responsibility to maintain a count of the number of “rollovers” is elsewhere. With 32-bit packet counters, the fastest rollover would be approximately 1,310 seconds (if all thirteen ports were sending to the same next-hop destination/end station). Note that the highest sustained traffic rate for a given PSDE (next hop) is one gigabit per second, since it all must traverse the same path. Additionally, when the IP Statistics function is enabled, forwarding performance will suffer slightly, since four extra tics per packet are needed to update and store the statistics.

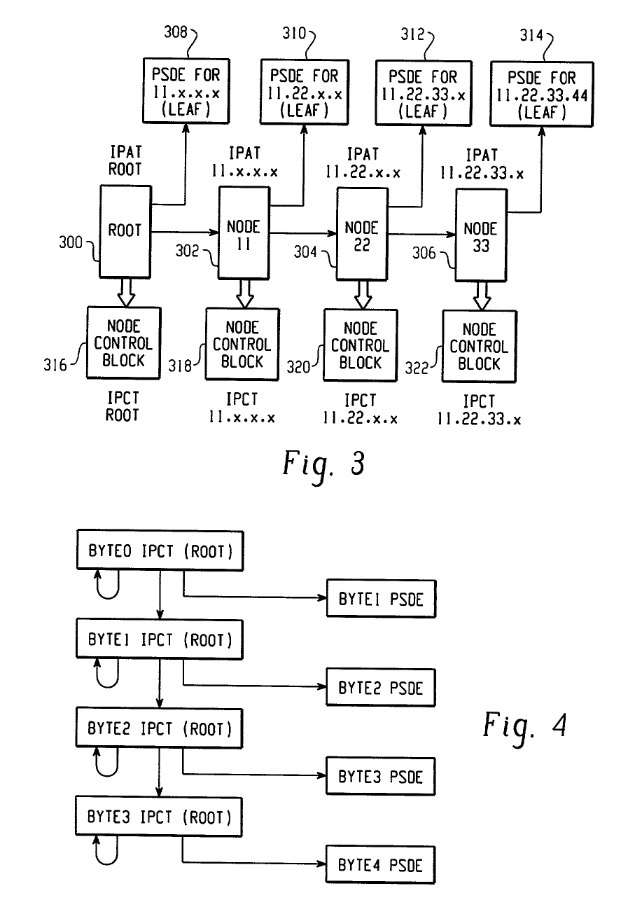

Referring now to FIG. 3, there is illustrated a flow diagram for address resolution where the maximum search distance is four levels, according to a disclosed embodiment. As indicated hereinabove, address resolution is based on a tree-like structure. The four levels (or nodes) include root level node 300, a first child node 302, a second child node 304, and a third child node 306. The root level node 300 and each child node (302, 304, and 306) in the tree is a table, in particular, denoted an IP Address Table (IPAT) that contains a child array of two hundred fifty-six pointers. Each IPAT has an associated IP Node Control Block Table (IPCT). Thus the root level node 300 has an associated root PSDE 308, the first child node 302 has an associated first PSDE 310, the second child node 304 has an associated second PSDE 312, and the third child node 306 has an associated third PSDE 314.

Note however, that although illustrated with both the IPAT of a subsequent node and the PSDE of the current node (e.g., IPAT 302 and PSDE 308), to show that either can be generated in accordance with the disclosed archtiecture, in reality the IPAT 302 and the PSDE 308 cannot coexist, since if the route is determined by 11.xx.xx.xx, then the PSDE 308 will be pointed to by the root IPAT 300, and the routing does not get to the IPAT 302. If, on the other hand, in addition to a route for 11.xx.xx.xx, there is a more detailed route for 11.22.xx.xx, then the IPAT 300 points to the first child IPAT 302, and not the root PSDE 308. Thus the root PSDE 308 does not exist. This applies similarly for IPAT 304 and PSDE 310, IPAT 306 and PSDE 312.

Each node also has a backtrack IPCT. Thus the root level node has associated therewith a root IPCT 316, the first child node 302 has an associated first child node IPCT 318, the second child node 304 has an associated second child node IPCT 320, and the third child node 306 has an associated third child node IPCT 322.

All searches start at the root node 300 (i.e., the IPAT Root), indexed by the first byte (or octet, in this particular embodiment) of the packet destination IP address. Each entry in the child array IPAT can point to another node IPAT, a PSDE or Resolution Pending Entry (RPE), backtrack to the IPCT, or it may be invalid (invalid can also signal source and/or destination filtering). If the indexed entry points to another child node IPAT, the next byte of the packet destination IP address is used to index into that table. This progresses until a table entry of routing information is found that is either null/invalid, points to either the PSDE (a “Leaf” node) or RPE, or is set to “Backtrack”.

If the search ends with a pointer to the PSDE, then the packet is forwarded using the information in the PSDE. If the final entry is null/invalid, a “Route Request” message is sent to the software manager 103. The RPE is created if resources are available, and adds the packet pointer to the RPE queue. Note that there are four codes used for “invalid” child array entries. Three of the codes are used to declare that the address is under Source or Destination filtering (or both), in which case, the packet should just be dropped. The fourth “invalid” code causes a “Route Request” to be sent. Finally, if the search ends with an array entry set to “backtrack”, then the route information from the previous (or “parent”) IPCT is used to forward the packet. Note that if it is also set to “backtrack”, then the information is retrieved from its parent. Each IPAT contains a control block that contains the forwarding information needed. The “Backtrack” bits are used when there are a few entries in the IPAT with specific route information, while the rest of the entries all use the same (different) information (for example, some entries may have a longer subnet mask, and thus have more specific information). In this case, the search must “backup” to retrieve the information from the previous node IPCT (the same information that would have been in the PSDE if the current address table had been a leaf). Examples are provided hereinbelow more clearly describe operation of the disclosed architecture.

Referring now to FIG. 4, there is illustrated a backtrack scenario, in accordance with a disclosed embodiment. As mentioned hereinabove, the IP address contains 4-byte numbers in the format of aa.bb.cc.dd, where aa is byte zero and dd is byte three. Following are three case scenarios that illustrate the backtrack feature: first, route at Byte0 IPCT—backtrack at Byte1,2,3 IPCT; second, route at Bytel IPCT—backtrack at Byte2,3 JPCT; and third, route at Byte 2 IPCT—backtrack at Byte3 IPCT.

The following Table 1 summarizes the first case where routing is according to the first byte, Byte0 IPCT, and backtracking from the remaining three bytes, i.e., backtrack at Bytel,2,3 IPCT.

TABLE 1
Case 1 - Route at Byte0 IPCT - Backtrack at Byte1, 2, 3 IPCT.

| Level | 01 × Current IPCT | 00 × Next IPCT | Cache | Notes |
|---|---|---|---|---|
| Byte0 Valid route | 010 RootHdl | 000 NextHdl | RootHdl | By default, root |
| (root) | 011 don't care | 001 NextHdl | | IPCT is latched |
| Byte1 No route | 011 don't care | 001 NextHdl | RootHdl | |
| (backtrack) | | | | |
| Byte2 No route | 011 don't care | 001 NextHdl | RootHdl | |
| (backtrack) | | | | |
| Byte3 No route | 011 don't care | Not valid | RootHdl | |
| (backtrack) | | | | |

The following Table 2 summarizes the second case where routing is according to the second byte, Bytel IPCT, and backtracking from the bytes two and three, i.e., backtrack at Byte2,3 IPCT.

TABLE 2
Case 2 - Route at Byte1 IPCT - backtrack at Byte2, 3 IPCT.

| Level | 01 × Current IPCT | 00 × Next IPCT | Cache | Notes |
|---|---|---|---|---|
| Byte0 | 010 RootHdl | 000 NextHdl | RootHdl | B does not |
| (root) | 011 don't care | 001 NextHdl | | work, no latch |
| Byte1 | 010 CurHdl | 000 NextHdl | RootHdl | B = 0, latch |
| Valid route | | | | Byte2Hdl |
| Byte2 No route | 010 CurHdl | 001 NextHdl | Byte2Hdl | Duplicate route |
| (backtrack) | 011 don't care | | | info from |
| | | | | Byte1 to Byte2 |
| | | | | IPCT |
| Byte3 No route | 011 don't care | Not valid | Byte2Hdl | |
| (backtrack) | | | | |

The following Table 3 summarizes the third case where routing is according to the third byte, Byte2 IPCT, and backtracking from the fourth byte, i.e., backtrack at Byte3 IPCT.

TABLE 3
Case 3 - Route at Byte2 IPCT - backtrack at Byte3 IPCT.

| Level | 01 × Current IPCT | 00 × Next IPCT | Cache | Notes |
|---|---|---|---|---|
| Byte0 | 010 RootHdl | 000 NextHdl | RootHdl | |
| (root) | 011 don't care | 001 NextHdl | | |
| Byte1 | 011 don't care | 000 NextHdl | RootHdl | B = 0, |
| | 010 CurHdl ® | | | latch Byte2Hdl |
| Byte2 | 010 CurHdl | 001 NextHdl | Byte2Hdl | |
| Valid route | 011 don't care | | | |
| Byte3 No route | 011 don't care | Not valid | Byte2Hdl | |
| (backtrack) | | | | |

As a packet is received from the MAC ports, the header is captured, and once the entire packet has been received (and the checksum verified), the packet header is passed to preprocessor logic of the search engine 110. The preprocessor logic examines the packet header and formats a switch Route Request message for the search engine 110. The preprocessor logic needs to put the protocol Source and Destination Port numbers (sixteen bits each), i.e., “logical port numbers”, in a Hash Key FIFO. These logical port numbers are used by the search engine 110 to set transmit priority bits (i.e., “XP” bits) if they match one of the sixteen programmed comparison values. The search engine 110 pulls switch Route Request messages from a queue and processes them in order. These switch requests fall into four broad categories: Bridged (unicast) packets—the destination MAC address does not match a switch MAC address; Routed/CPU packets—the destination MAC address matches a switch MAC address; Multicast packets; and CPU packets, e.g., BPDU (Bridge Protocol Data Unit), ARP packets, non-IP packets with destination addresses matching a switch address, etc.

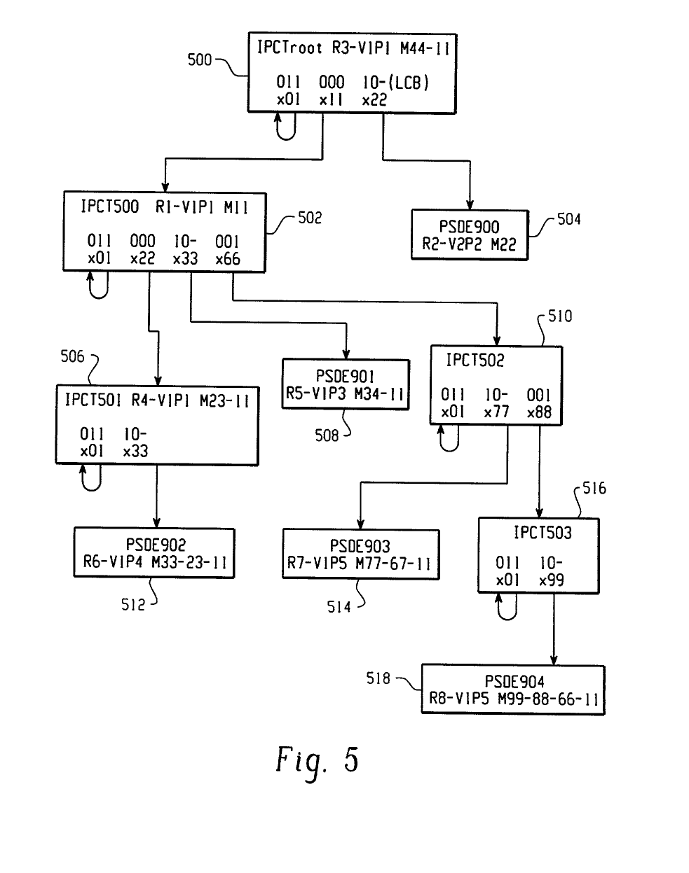

Referring now to FIG. 5, there is illustrated a flow diagram in accordance with the following algorithm code. The following definitions are used: “route add RI” adds a route named R1; “dip” is the destination IP address; “nhop” is the next hop IP subnetwork; “nml” is the netmask length in bits (so a value of “8” indicates the first byte); “ma” is the MAC address; “vid” is the VLAN ID outgoing subnet; and “port” is the outgoing port designator. Assuming a one-megabyte cache memory 116 for the search engine 110, the following sample route definition code can be used. #route_add R1 dip=11.00.00.00 nhop=11.00.00.00 nml=8 mac=11 vid=1 port=1 #route_add R2 dip=22.00.00.00 nhop=22.00.00.00 nml=8 mac=22 vid=2 port=2 #route_add R3 dip=00.00.00.00 nhop=11.44.00.00 nml=0 mac=44-11 vid=1 port=#route_add R4 dip=11.22.00.00 nhop=11.23.00.00 nml=16 mac=23-11 vid=1 port=#route_add R5 dip=11.33.00.00 nhop=11.34.00.00 nml=16 mac=34-11 i1 vid=1 #route_add R6 dip=11.22.33.00 nhop=11.23.33.00 nml=24 mac=33-23-11vid=1 port=4 #route_add R7 dip=11.66.77.00 nhop=11.67.77.00 nml=24 mac=77-67-11 vid=1 port=5 #route_add R8 dip=11.66.88.99 nhop=11.68.90.00 nml=32 mac=99-88-66-11 vid=1 port=5

The backtrack bit in the IPAT entry indicates if the current IPCT contains a valid or invalid route, where B=0 indicates current IPCT contains valid route; and B=1 indicates current IPCT does not have the route information. The backtrack bit in the IPAT entry also indicates if the next level handle should be cached or not, where B=0 indicates the next IPCT contains a valid route, and should be cached, and B=1 indicates the next IPCT does not contain a valid route, and so should not overwrite the cache memory 116.

When hardware performs a new L3 (Layer 3) search, it initializes the cache memory 116, wherein the cache memory 116 now contains an entry that points to the root IPCT handle. Additionally, the root IPAT will not cache the next IPCT handle in the cache memory 116, even if B=0. The general format of the IPAT is summarized in the following Table 4.

TABLE 4
Format of IPAT (512 bytes)

| | | | | | | | |
|---|---|---|---|---|---|---|---|
| L | C | B | Handle1 (13 bits) | L | C | B | Handle0 (13 bits) |
| L | C | B | Handle3 (13 bits) | L | C | B | Handle2 (13 bits) |
| L | C | B | Handle5 (13 bits) | L | C | B | Handle4 (13 bits) |
| | | | . . . | | | | . . . |
| L | C | B | Handle251 (13 bits) | L | C | B | Handle250 (13 bits) |
| L | C | B | Handle253 (13 bits) | L | C | B | Handle252 (13 bits) |
| L | C | B | Handle255 (13 bits) | L | C | B | Handle254 (13 bits) |

Various definitions in the table include the following: L-leaf; C-current IPCT; and B—indicates the backtrack bit (valid in LC=00 & 01 mode). The descriptions are the following:

When L=0 and C=0: B (1 bit) Handle (13 bits)—point to next IPAT table, where the pointer (ptr) =Handle <<9.

If B=1, the backtrack bit is set, if the next level IPCT does not contain a valid route.

If B=0, the next level IPCT contains valid route.

The B bit is for search engine optimization.

When L=0 and C=1: B (one bit) Handle(thirteen bits)—point to current IPCT, when the pointer (ptr) =Handle<<5.

B=1 set when the current level IPCT does not contain a valid route. The Handle is not used.

B=0 when the current level IPCT contains a valid route. The Handle is used, and should be pointed to the current IPCT.

When L=1 and C=0: Handle(now 14 bits)—point to PSDE/RPE leaf, where the pointer (ptr) =Handle<<5.

The B bit is not used, so the Handle contains one extra bit.

When L=1 and C=1: a NULL condition exists. The B bit is in a “don't care” state.

Handle (Hdl) & Address Translation:

IPCT handle (13 bits) =IPAT handle—IPCT addr>>5 —IPAT addr>>9.

PSDE/RPE handle (14 bits) =PSDE/RPE addr>>5.

PSDE/RPE addressable range 0 to 512k bytes.

IPCT addressable range 0 to 256k bytes.

IPAT addressable range zero to four megabytes.

Each of the IPATs has an identical format, with an array of pointer handles, and a control block. Since each array entry is two bytes, each table of two hundred fifty-six will be 512 bytes total. Each IPAT has the corresponding IPCT, which contains the management information needed to age the tables, as well as packet forwarding information. The filed descriptions of the IPAT are as follows:

L (Leaf): When set, this node is a leaf node. The Handle points to a PSDE or RPE, and not another table.

C (Current IPCT): indicate to use current IPCT of this node as route (C=1) or look for next IPAT entry (C=0).

B (Backtrack): indicates to use the parent IPCT as a route when B=1. Valid only when LC=00 or 01. Note that the handle bits are fourteen bits if L=1&C=0, which is pointed to PSDE/RPE. Otherwise, the handle is thirteen bits.

Handle: 0×FF is Invalid/Null; 0×FE is “invalid/Source filtering” ; 0×FD is “invalid/Destination filtering”; 0×FC is “invalid/Source AND Destination filtering”; 00 through 0×FB are valid handles for either IPATs (for address bits [20:9]) if L is zero, or PSDEs/RPEs (for address bits [18:4]).

The usage and actions for the above three bits are summarized as follows:

L=0, C=0: B (lbit) Handle (13bits)—point to next IPAT, where B is the backtrack bit that contains same value as in corresponding IPCT, and the B bit is for search engine optimization;

L=1, C=0: Handle (fourteen bits)—points to PSDE/RPE leaf;

L=0, C=1: B (one bit) Handle (thirteen bits)—points to current IPCT; and

L=l, C=l: NULL condition.

Note that handle & address translation is in the firmware 108 when using the optimization memory allocation.

IPCT handle (13 bits)=IPCT addr>>5

IPAT handle (13 bits)=IPAT addr>>9

PSDE/RPE handle (14 bits)=PSDE/RPE addr>>5

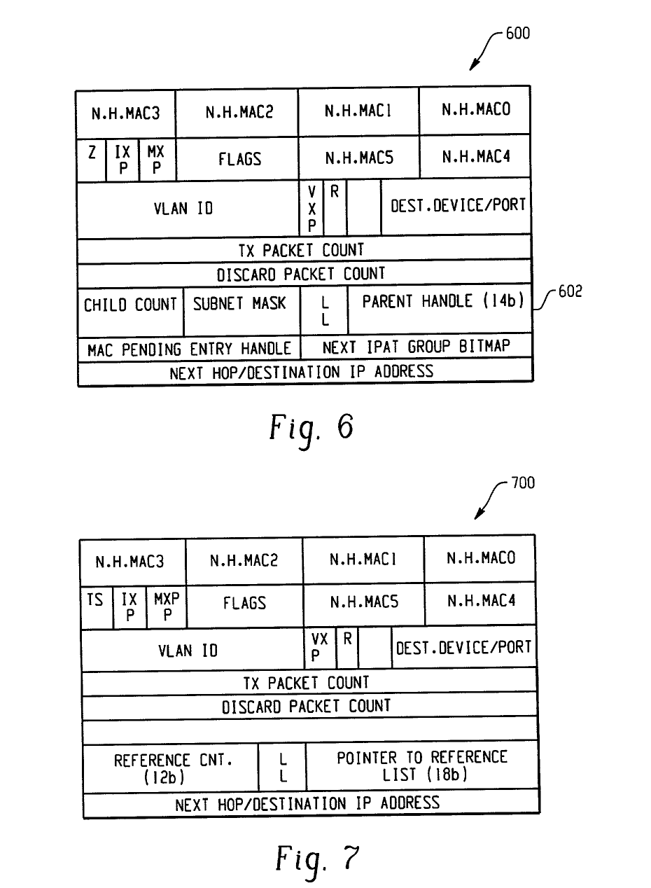

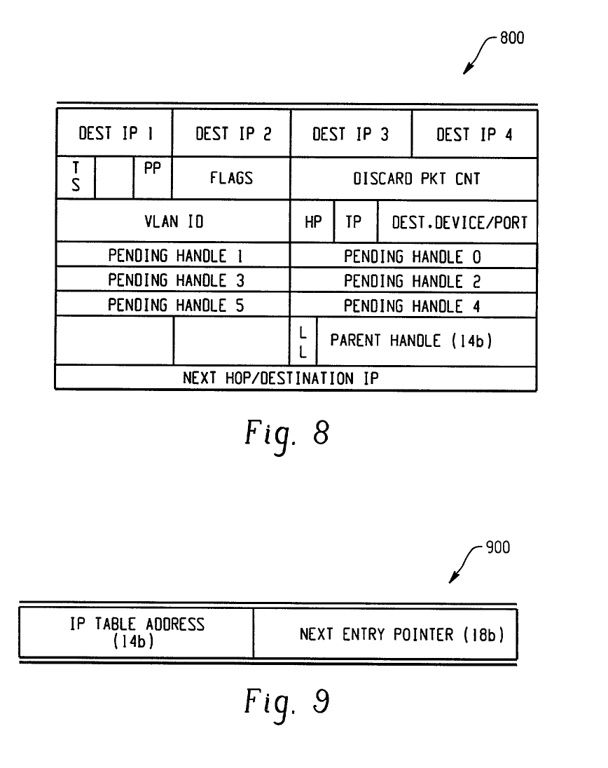

Referring now to FIG. 6, there is illustrated an IPCT structure 600. Note that the IPCT structure 600 is substantially identical to the formats the PSDE of FIG. 7 and RPE of FIG. 8, except for the sixth double word 602 (i.e., the Parent Handle in the IPCT 600 and, the Pointer to Reference List and Reference Count in the PSDE of FIG. 7). The field descriptions for the IPCT structure 600 are as follows:

N.H. MACx denotes the next hop MAC Address;

B (Backtrack) denotes to use the parent control block information for packet forwarding (also, there is one spare bit between “B” and “IXP”);

IXP denotes the XP value+valid bit for IP Destination Address-based priority mapping; precedence level 2;

MXP denotes the XP value+valid bit for MAC Destination Address-based priority mapping; precedence level 4;

Flags: Valid—Next Hop MAC, VLAN ID, & Destination Device/Port are valid;

Spare—(RPE Bit in PSDE);

Router_IP (CPU IP Address)—Forward packet to CPU;

Tag Enable—Packet should be forwarded with VLAN Tag inserted;

Port Trunk—Member of Port Trunk Group (Destination Device/Port holds group number);

Subnet Multicast—Send Multicast Switch response using Multicast Group Index from MRL+Dest. Device/Port fields); and

Encapsulation(1:0)—Encapsulation Type; if this does not match the received packet type, packet is forwarded to the CPU;

VLAN ID—Next Hop VLAN ID (Priority included);

VXP—XP value+valid bit for Destination VLAN-based priority mapping; precedence level 6;

Rate (R)—set if the destination is a Gigabit port;

Destination Device/Port—the 5—bit destination device ID, and 4—bit port number;

Transmit Byte Count—if IP Statistics is enabled, this is the count of packets transmitted for this entry; when the counter rolls over, a message is sent;

Transmit Packet Count—if IP Statistics is enabled, this is the count of packets transmitted for this entry; when the counter rolls over, a message is sent;

Discard Packet Count—if IP Statistics is enabled, this is the count of discarded packets for this entry; when the counter rolls over, a message is sent;

Parent Handle—handle pointing to previous table in hierarchy;

LL (Level)—a 2—bit code for the “byte” level of this entry in the IP address hierarchy;

Subnet Mask—a 5—bit field describing the length of the subnet mask; there are three bits available for flags in this byte;

Child Count—the number of valid entries in the child array; when this reaches zero, the table can be deleted;

Next Hop/Destination IP—the IP address for this entry;

Mac Pending Entry Handle (MPE) pointer—when route is resolved, but Mac address mapping is not valid yet, points to MPE that queues up FCBs (file control blocks), until the ARP is resolved, i.e., a valid route with an unresolved next—hop MAC address;

Next IPAT group bitmap—each bit represents sixteen IPAT entries; bit is turned on when at least one entry contains L=0, C=0; and

Z—must be tied to 0.

Note that the dark shaded area is unused, and the seven fields below the Discard Packet field (i.e., the last two double—words) are only used internally. Additionally, the hardware treats all but the 4^{th} and 5^{th} double words as “read only”. The 4^{th} & 5^{th} double words are the IP statistics. The search engine 110 is responsible for updating the IP statistic information for each packet, as the packet is being routed. Referring now to FIG. 7, there is illustrated a PSDE structure 700. As mentioned hereinabove, the PSDE is the leaf data structure that provides the information needed to forward packets. The same data structure is used for direct-attached nodes and for Next Hop Routers. The PSDE thirty-two bytes long, the same as the RPE structure of FIG. 8. A single free-list can serve both the PSDEs and RPEs, since both use 32-byte structures. The PSDE data structure 700 is nearly identical to the IPAT Node Control Block (NCB) to simplify management and hardware use of the table. The Reference Count field counts the number of child array handles pointing to this entry. For direct-attached nodes, the count will be one, but if the PSDE is for a Next-Hop Router, the number could be large. The field descriptions for the PSDE structure 700 are as follows:

N.H. MACx denotes the Next Hop MAC Address;

TS (Timestamp)is a 2-bit field used for aging;

IXP is the XP value+valid bit for IP Destination Address-based priority mapping; precedence level 2;

MXP is the XP value+valid bit for MAC Destination Address-based priority mapping; precedence level 4;

Flags: Valid—Next Hop MAC, VLAN ID, & Destination Device/Port are valid′

RPE—this structure is an RPE;

Router_lp (CPU IP Address)—forward packet to the CPU;

Tag Enable—packet should be forwarded with VLAN Tag inserted;

Port Trunk—member of Port Trunk Group (Dest. Device/Port holds group number);

Subnet Multicast—send a Multicast Switch response using Multicast Group Index from MRL+Dest. Device/Port fields;

Reserved (R) (one bit);

Encapsulation—encapsulation type—if this does not match the received packet type, the packet is forwarded to the CPU;

VLAN ID—next hop VLAN ID (Priority included);

VXP—the XP value+valid bit for Destination VLAN-based priority mapping; precedence level 6;

Destination Device/Port—the 5-bit destination device ID, and 4-bit port number;

Transmit Packet Count—if IP Statistics is enabled, this is the count of packets transmitted for this entry; when the counter rolls over, a message is sent;

Discard Packet Count—if IP Statistics is enabled, this is the count of discarded packets for this entry; when the counter rolls over, a message is sent;

Pointer to Reference List—if the Reference count is greater than one, there is a list of pointers maintained of IPATs that point to this PSDE; this list is used for aging, since all references to this structure must be deleted before the structure can be deleted; if the reference count is one, this is the parent pointer;

LL {Level(1:0)}—the level of this node in the tree (ranging from zero to three);

Reference Count—the number of child array entries pointing to this entry; if this entry is for a next-hop router, the number could be large; for a direct-attached node, it is one; this is the number of entries in the reference list; and

Next Hop/Destination IP—the IP address for this entry.

Referring now to FIG. 8, there is illustrated an RPE structure 800. The RPE is a variation on the PSDE that can be used to keep track of outstanding Route Request messages. When the search engine 110 cannot resolve an IP address (e.g., no valid route is found), it will send the Route Request message to the software manager 103 via the firmware 108. The Route Request message contains the FCB handle for the packet, and the destination IP address. The Route Request message is sent to the CPU 102, where an RPE is created with the packet FCB handle in the first pending entry, and the pending packet count set to one. The handle for the RPE is then set in the proper location in the IPAT, so that if a large number of packets with the same destination address is received, the search engine 110 will start dropping packets after it sees that the RPE is full (rather than sending Route Request messages for each packet).

The RPE structure 800 allows up to six pending packets to be queued while waiting for the Route Response message. Any packets received beyond these six will be dropped. This ensures packet ordering, while keeping the interface simple and efficient. Note that ifIP Statistics is enabled, only five packets can be pending due to the dropped packet counter. When the search engine 110 drops a packet due to too many pending, it increments the “Dropped Packet Count”. Likewise, when a Route Request or Route Pending message is received and the RPE queue is full, the packet is dropped and the dropped (or discard) packet counter is incremented. Once the Route Response is received, corresponding switch response messages for then enqueued packets are generated from the firmware 108 to the search engine 110 to signal the search engine 110 to send out the packets in the queue, and the byte count is summed up to initialize the PSDE statistics correctly.

When the search engine 110 detects an RPE during an address search, it checks the Pending Packet field, and if it is greater than five (i.e., IP Statistics is disabled, so up to six outstanding packets can be held) or greater than four (i.e., when IP Statistics is enabled, thus one of the six spaces is taken for statistics) the packet is dropped (and ifIP Statistics is enabled, the discard packet counter is incremented). This way, a large number of Route Request messages for packets that have to be dropped will not need to be processed. If the Pending Packet field is less than six (or less than five), the hardware will send a Route Pending message that includes the FCB and RPE handles. The pending packet list is then supplemented.

Once the Route Response message is received from the CPU 102, switch responses are generated for the pending packets, and a PSDE generated with the next hop information (and the IP statistics from the RPE) with the IPAT updated with the PSDE handle.

Note that the “Route Request”, “Route Pending”, and “Counter Rollover” messages are sixty-four bits long so that the IP Address & FCB handle, RPE and FCB handles, and IP address & RPE handles can be carried, respectively. Additionally, the message queue could be deeper than thirty—two entries, since there will be more activity for Layer 3 processing (probably 512 bytes total, or 64-128 entries). Finally, the “Frame Length” field in the preprocessor logic output is eleven bits so that the TX packet length can be calculated accurately.

Note also that the IXP, MXP, VXP, and R bits are not known until the route has been resolved, so these positions have been reused for the pending packet pointers.

The field descriptions for the RPE 800 structure are as follows:

Dest IP denotes the Destination IP address;

TS (Timestamp)—a 2-bit field used for aging;

PP denotes a Pending Packet Count for the number of packets queued on this RPE (ranging from zero to six);

HP denotes the Head Pointer, which is the pointer to the first pending packet handle;

TP denotes the Tail Pointer, which is the pointer to the next empty pending handle slot;

VLAN ID denotes the next hop VLAN ID (invalid until Route Response);

Flags: Valid—next hop MAC, VLAN ID, & Destination Device/Port are valid;

RPE—the Routing Pending Entry;

Router_IP (CPU IP Address)—forward packet to the CPU;

Tag Enable—packet should be forwarded with VLAN Tag inserted;

Port Trunk—member of Port Trunk Group (Dest. Device/Port holds group number);

Subnet Multicast—send multicast switch response using Multicast Group Index from MRL2+Dest. Device/Port fields;

Reserved a 1-bit field reserved for later use; and

Encapsulation—encapsulation type; if this does not match the received packet type, the packet is forwarded to the CPU;

Destination Device/Port—invalid, until Route Response;

Pending Handle—the FCB handle of packets waiting for the Route Response; note that bits[15:12] are unused (so the source port could be stored here);

Discard Packet Count—ifIP Statistics is enabled, this is the count of discarded packets for this entry; when the counter rolls over, a message is sent;

Parent Handle—handle pointing to previous table in hierarchy;

LL (Level) a 2-bit code for the “byte” level of this entry in the IP address hierarchy; and

Next Hop/Destination IP—the IP address for this entry.

Referring now to FIG. 9, there is illustrated a sample PSDE reference list data structure 900. There are two data structures that need to be managed; the IPATs (Child Array+Node Control Block), and the PSDE/RPE blocks. Since the IPATs hold pointers to the PSDEs, the IPATs cannot be deleted (i.e., added to the free list) until all of the pointers have first been deleted (so that PSDEs are not left active in memory with nothing pointing to them). The IPATs are deleted only when their child count reaches zero (meaning no valid pointers are in the child array).

The PSDEs and RPEs contain a 2-bit timestarnp (i.e., “TS” bits) which are used for aging. When a PSDE/RPE has been inactive long enough for the “TS” bits to transition from a “01” to “00”, a message is sent indicating that it is “discard eligible”. The entry is then deleted after deleting all pointers that reference it. For direct—attached nodes, this is fairly easy, since there will only be one pointer to the PSDE that needs to be invalidated. For next-hop router entries, there could be many pointers to the PSDE. All of these pointers must be invalidated before the PSDE can be deleted. To facilitate this, a link-list of reference pointers is created and maintained for each next-hop router PSDE. The “Pointer to Reference List” and “Reference Count” are used for this purpose. Each time a new pointer is added (in an IP Address Child Array entry) that points to a given PSDE, a new entry will be added to the Reference List for that PSDE. When a PSDE is eligible for deletion, the Reference List is worked through to invalidate all the pointers to the PSDE, and then the PSDE is deleted (add it to the free list).

The PSDE Reference List requires four bytes per reference, but are only used for next-hop routers, so there will not be too many of these lists.

The PSDE and RPE aging is accomplished by a hardware scanner. The mechanism is to scan all PSDEs/RPEs and decrement the TS field (hardware will set the field to “11” when an entry is accessed). Once the TS field is “00”, the entry is eligible to be deleted. When the hardware scan detects an entry with a TS field of “01”, it sends a message, and sets the field to “00”. Note that in the case of RPEs, the TS bits will only get set to “11” when a Route Request message is sent up to the CPU 102. If no Route Response message is received within two aging cycles (e.g., two and one—half to five minutes for a 10-minute lifetime setting), the RPE will be eligible for deletion. The hardware does not delete the PSDEs and RPEs, but only maintains the “TS” bits, and sends “discard eligible” messages.

The aging scanner works from a list of handles generated by the software manager 103 at initialization time. This list requires two bytes per PSDE/RPE. The scanning logic walks through this list of handles, and goes to each PSDE/RPE in order to decrement the TS field. Since the handle is only fourteen bits, the MSB (Most Significant Bit) can be used to mark handles that are eligible for deletion. When some PSDEs/RPEs are to be freed up, the handle list is scanned for entries with bit fifteen set. The scanning rate is maintained in a register.

Note that if an RSE is aged-out, each pending packet must get a “Drop” switch response to free up the frame data buffers (FDBs). Note that the RPE contains the pending packet handle, so when the RPE is aged out (a timeout), the FDBs are freed up.

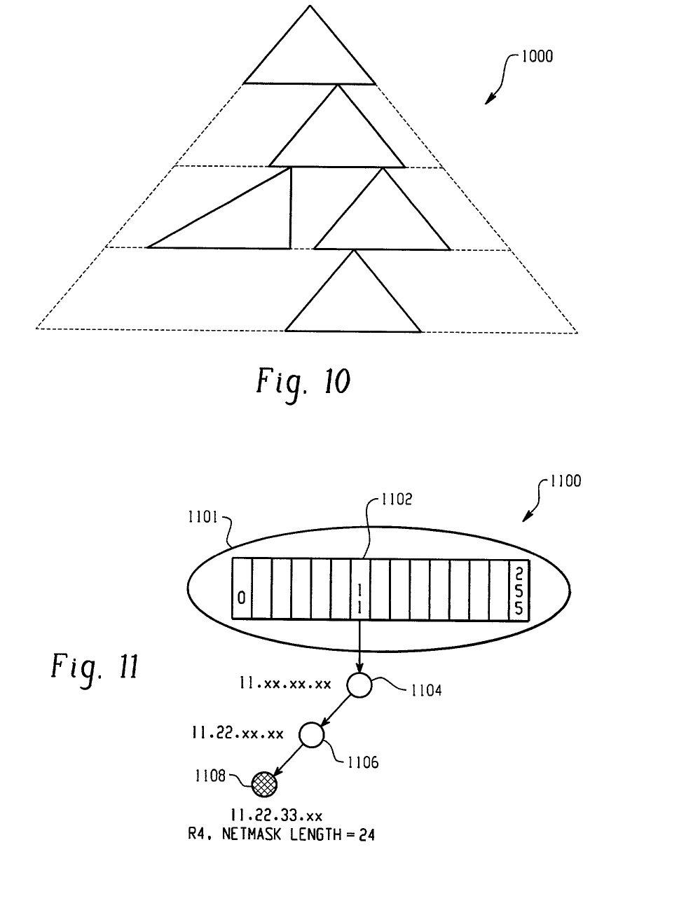

Referring now to FIG. 10, there is illustrated a general diagram of a routing tree 1000 (similar to routing tree 204), in accordance with a disclosed embodiment. The firmware 108 maintains the cached routing tree 1000 of at most four levels, one level for the root (the leftmost byte) and three levels for the remaining bytes of a 4-byte IP address. As indicated hereinabove, the routing tree 1000 contains just a subset of the routing information stored in the software database 104. The routing tree 1000 consists of a set of routing nodes with at least one root node (i.e., the apex of the topmost level). Each routing node contains the following node information: two hundred fifty-six child pointers (i.e., pointers to the next level child nodes for a non-leaf node); a pseudo_child bitmap of two hundred fifty-six bits; a child count that is a count of non-null child pointers; a parent pointer that is a pointer back to its parent node; a next hop pointer that is a pointer to a data structure containing next-hop information; a netmask length, which is the netmask length of the most specific routing entry covering this node in the routing table of the software database 104; a netmask length of the default route is zero; the netmask length is significant only if the next-hop pointer!=NULL; several flags, including (1) a leaf flag which is indicates that this node is a leaf in the routing tree 1000, (2) a backtrack flag, which indicates the route according to parent node information, and a (3) local flag, which indicates this router and the destination are in the same subnet; a next aging pointer and a previous aging pointer, where both are pointers to chain routing nodes with child counts equal to zero, in an aging list; a time stamp that is the time of the most recent reference to a routing node (the firmware 108 updates only the time stamps of routing nodes with child count equal to zero); and level, which is the level of this node in the routing tree 1000 (the root is at level zero).

A routing node is a leaf, if there does not exist more specific routes under that node in the routing table in the software database 104. The k^{th} bit of a node pseudo_child bitmap is set to one, if the route for its k^{th} child and all the descendants under the k^{th} child is the same as the node.

The initial state of the routing tree 1000 consists of just one routing node (i.e., the root node). In an initialized state, the following settings are noted: the child count is zero; all two-hundred fifty-six child pointers are set equal to the parent pointer, which is NULL; the next—hop pointer is set to NULL; the netmask length is zero; the leaf flag equals the backtrack flag, which is zero; the local flag is zero; the pseudo_child bitmap is zero; the aging pointers equal the NULL state; the time stamp is zero; and the level is zero.

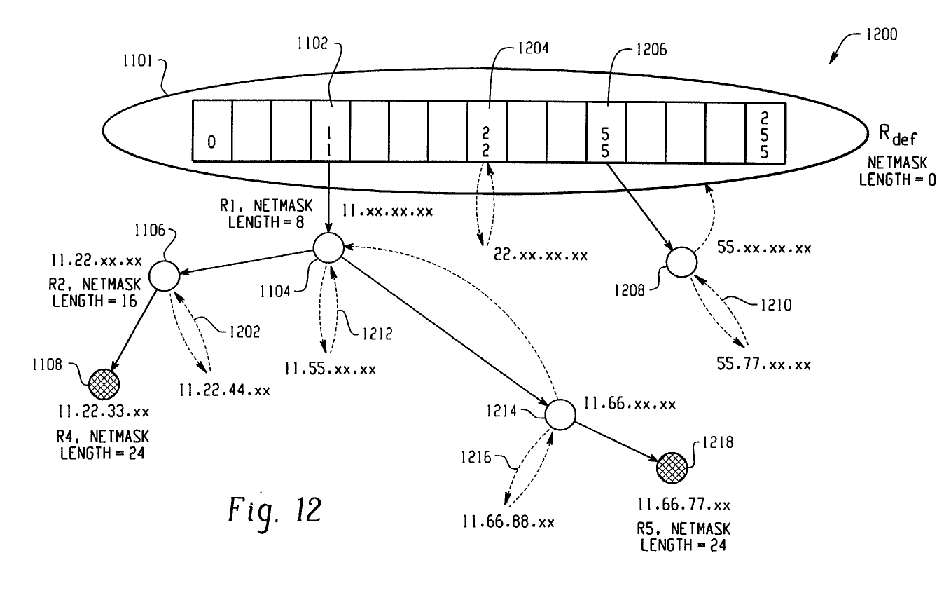

Referring now to FIG. 11, there is illustrated a first example routing tree 1100 utilizing a software routing table. For discussion purposes, assume the software routing table for the discussion of FIG. 11 and FIG. 12 contains the following route entries: 11 .xx.xx.xx routes to R1, 11.22.xx.xx routes to R2; 11.33.xx.xx routes to R3; 11.22.33.xx routes to R4; 11.66.77.xx routes to R5; and 55.66.xx.xx routes to R6, with default routes to the default router (denoted R_{def}).

With the cached routing tree 100 starting from an initialized state, when a packet destined for the address 11.22.33.44 is received, the firmware 108 visits the root node 1101 and finds that for an 0x11 child 1102, the pseudo_child bit is zero and the child pointer equals NULL. Thus the firmware 108 sends a Route Request for 11.22.33.44 to the software manager 103, which accesses routing table data of the routing software database 104. The routing software manager 103 responds back to firmware 108 with a Route Response having the information<11.22.33.44, R4, netmask length-24, DMB-3, and flags =0>(where < and > delineate the response field information). The firmware 108 then updates the routing tree 1100 of FIG. 11, as follows: at the root node 1101, the 11^{th} child pointer is the address of a first child node 1104 (11.xx.xx.xx), which first child node 1104 has a child count of one (indicating that firs child node 1104 has only the one child node, that being a second child node 1106).

The entries associated with the first child node 1104 (11.xx.xx.xx) are the following: leaf flag =0; backtrack flag =0; next-hop pointer =NULL; the 22_{nd} child pointer is the address of the second child node 1106 (i.e., 11.22.xx.xx); the 22^{nd} pseudo_child bit=0; the child count=1; and the parent pointer is the address of root node 1101.

The entries associated with the second child node 1106 (i.e.,11.22.xx.xx) are the following: leaf flag=0; backtrack flag=0; next-hop pointer =NULL; the 33^{rd} child pointer is the address of a first leaf node 1108 (i.e., 11.22.33.xx); child count=1; and the parent pointer is the address of the first child node 1104 (i.e., 11.xx.xx.xx).

The entries associated with the first leaf node 1108 (i.e., 11.22.33.xx) are the following: leaf flag=1; backtrack flag=0; next-hop pointer is the pointer having R4 information that points to a subsequent structure that may come into existence; netmask length=24; child count=0; and the parent pointer is the address of second child node 1106 (i.e., 11.22.xx.xx).

When more packets destined to the first leaf node 1108 (11.22.33.xx) are received, the firmware 108 traverses the cached routing tree 1100 and stops at the first leaf node 1108 (11.22.33.xx), when it finds that the value of leaf flag −1. Thus those packets will then be forwarded to the address associated with R4.

Generally speaking, the software manager 103 replies to the firmware 108 with a Route Response message having the general information<IPx, next hop router Ry, netmask length=d, DMB=n, flags>, if Ry is the next hop of the route chosen for the address IPx, netmask length of the route chosen=d, and the rightmost bit of IPx used by software manager 103 to make the route decision falls within byte n (where byte n is the decision-making byte, where 1 ≦n≦4 and the leftmost byte is byte one). For example, the address of 12.34.xx.zz has the rightmost bit of “4”, which is used by the software manager 103, residing in the second decision—making byte, where “12” is in the first byte, “34” is in the second byte, “xx” is in the third byte, and “zz” is in the fourth byte.

There are two flags in the flag field. The local_indicator flag is set to one, iff (denoting if and only if) this router is a member of the destination subnet. The router_IP flag is set to one, iff IPx is one of the router IP addresses. Note that the Route Response message also contains the next hop router MAC (Media Access Control) address, the next hop VLAN ID, and the next hop Port ID.

Referring now to FIG. 12, there is illustrated a resulting routing tree 1200 when continuing with packet processing according to the routing tree 1100 of FIG. 11. A packet received with an address of 11.22.44.xx results in the firmware 108 visiting the second child node 1106 to determine that a 0x44 child pointer is NULL, causing the firmware 108 to send a Route Request message to the software manager 103. After receiving back a Route Response message, the firmware 108 then updates its cached routing tree 1100, now denoted as routing tree 1200 for the additional entries, as follows: the first child node 1104 (11.xx.xx.xx) has a leaf flag=0, backtrack flag=0, next-hop pointer points to the structure with R2 information (which is the second child node 1106), netmask length=8; the 22^{nd} child pointer is the address of the second child node 1106 (11.22.xx.xx), the 22^{nd} pseudo_child bit=0 (since no pseudo child exists from this node 1104 at this time); the 44^{th} child pointer is NULL, the 44^{th} pseudo_child bit=1 (denoting the creation of a first pseudo child 1202), child count=1 (for the first leaf node 1108), and the parent pointer of the second child node 1106 is the address of the first child node 1104. Further packets destined to 11.22.44.xx will be forwarded to R2 (i.e., the second child node 1106).

When a packet destined to the address of 22.33.44.55 is received, the firmware 108 visits the root node 1101 of the cached routing tree 1200, and finds that for an 0x22 child 1204, the pseudo_child bit is zero, and the child pointer is NULL. Thus the firmware 108 sends a Route Request message to the software manager 103 for the address 22.33.44.55, which software manager 103 accesses the routing table in the routing software database 104. The routing software manager 103 replies back to the firmware 108 with a Route Response message that includes the information <22.33.44.55, R_{def}, netmask length=0, DMB=1, flags=0>. The firmware 108 sets the 0x22nd pseudo_child bit at the root node 1101 to one. Additionally, the firmware 108 sets the next hop router at the root node 1101 to the default router R_{def}. Further packets destined to 22.xx.xx.xx will be routed to the default router R_{def}.

When a packet destined to the address 55.77.88.99 is received, the firmware 108 visits the root node 1101 of the cached routing tree 1200 and finds that for a 0x55 child 1206, the pseudo_child bit=0 and the child pointer is NULL. The firmware 108 then sends a Route Request message to the software manager 103 to further access the routing database 104 for the address 55.77.88.99. The routing software manager 103 then replies back to the firmware 108 using a Route Response message with the information <55.77.88.99, R_{def}, netmask length=0, DMB=2, flags=0>. The firmware 108 then updates its cached routing tree 1200 as follows: the root node 1101 adds the 55^{th} child pointer to the address of a third child node 1208 (i.e., 55.xx.xx.xx), with a child count of two (i.e., the first pointer (or handle) from the 11^{th} child 1102 of the root node 1101 to the first child node 1104, and the second pointer (or handle) from the 55^{th} child 1206 of the root node 1101 to the third child node 1208). The third child node 1208 (55.xx.xx.xx) has associated therewith a leaf flag=0, backtrack flag=1, next-hop pointer=NULL, a 77^{th} child pointer=NULL, a 77^{th} pseudo_child bit=1 (for creation of the pseudo_child 1210, child count=0, and a parent pointer that is the address of the root node 1101. Further packets destined to the address 55.77.xx.xx will be routed to the default router R_{def}.

Assuming still further the receipt of a packet addressed to 11.55.66.77. The root node 1101 is visited, with the 11^{th} child 1102 pointing to R1, the first child node 1104. Further investigating the first child node 1104, the firmware 108 determines that the first child node 1104 has a 55^{th} child pointer=NULL, and thus sends a Route Request message to the software manager 103 for the address 11.55.66.77 for packets destined to address 11.55.66.77. The routing software manager 103 replies back to the. firmware 108 with a Route Response message having the information<11.55.66.77, R1, netmask length=8, DMB=2, flags=0>. The firmware 108 will then update its cached routing tree 1200 as follows: the first child node 1104 (11.xx.xx.xx) has a leaf flag=0, backtrack flag=0, next-hop pointer that is the pointer to a structure with R1 information, netmask length=8; the 22^{nd} child pointer=address of the second child node 1106 (11.22.xx.xx), the 22^{nd} pseudo child bit=0; the 55^{th} child pointer=NULL, the 55^{th}pseudo_child bit=1 (for the creation of a pseudo child 1212), child count=1 (representing the existence of its only child node at this time as the second child node 1106), and the parent pointer is the address of root node 1101. Further packets destined to 11.55.xx.xx will be forwarded to R1 (i.e., the first child node 1104).

Continuing on with updating of the cached routing tree 1200, when the firmware 108 receives a packet destined to 11.66.88.99, the root node 1101 is visited, with the 11^{th} child 1102 pointing to R1, the first child node 1104. Further investigating the first child node 1104, the firmware 108 determines that the first child node 1104 has a 66^{th} child pointer=NULL, and sends a Routing Request message for the address 11.66.88.99 to the routing software manager 103. The software manager 103 replies back to the firmware 108 with a Route Response message having the information<11.66.88.99, R1, netmask length=8, DMB=3, flags=0>. The firmware 108 then updates the cached routing tree 1200 as follows: the first child node 1104 (11.xx.xx.xx) has a leaf flag=0, backtrack flag =0, next hop pointer=pointer to a structure with R1 information, netmask length=8, the 22^{nd} child pointer is the address of the second child node 1106 (11.22.xx.xx), the 22^{nd} pseudo_child bit=0, the 55^{th} child pointer=NULL, the 55^{th} pseudo_child bit=1 (for the pseudo child 1212), the 66^{th} child pointer is the address of a fourth child node 1214 (11.66.xx.xx), the 66^{th} pseudo_child bit=0 (at this particular time in the example), and the parent pointer=address of root node 1101.

The fourth child node 1214 (11.66.xx.xx) then takes on the values leaf flag=0, backtrack flag=0, next-hop pointer=NULL, the 88^{th} child pointer=NULL, the 88^{th} pseudo—child bit-1 (for the creation of a pseudo child 1216), child count=0 (at this time in the example), the parent pointer=address of the first child node 1104 (11.xx.xx.xx). When more packets destined to the address of 11.66.88.xx are received, the firmware 108 forwards the packets to the fourth child node 1214 (11.66.xx.xx).

Continuing with the example, now assume that a packet destined for the address 11.66.77.88 is received. The firmware 108 visits node the first child node 1104 (11.xx.xx.xx), and then the fourth child node 1214 (11.66.xx.xx). Determining that the 0x77 child of the fourth node 1214 is NULL, the firmware 108 sends a Route Request message to the software manager 103 for the address 11.66.77.88. The routing software manager 103 sends back to the firmware 108 a Route Response message having the information<11.66.77.88, R5, netrnask length=24, DMB=3, flags=0 >. The fourth child node 1214 (11.66.xx.xx) updates its values of leaf flag=0, backtrack flag=0, next-hop pointer=NULL, 88^{th} child pointer=NULL, 88^{th} pseudo_child bit=1 (for the pseudo child 1216), 77^{th} child pointer=address of the a second leaf node 1218 (11.66.77.xx), the 77^{th} pseudo_child bit=0, child count=1 (for the second leaf node 1218), and the parent pointer is the address of the first child node 1104 (11.xx.xx.xx). The values of the second leaf node 1218 become, leaf flag=1, backtrack flag=0, next-hop pointer is the pointer to a structure with R5 information (i.e., subsequent to that second leaf node 1218), netmask length=24, child count=0, and parent pointer is the address of the fourth child node 1214 (11.66.xx.xx), When more packets destined to 11.66.77. xx are received, the firmware 108 forwards the packets to the address associated with R5.

When an ARP (Address Resolution Protocol) Request message for IPx is received or the ARP mapping for IPx is changed, the software manager 103 sends an ARP Response message back to the firmware 108 with the information<IPx, MAC address, VLAN, Port ID, flags>. There is only one flag in the flags field, i.e., the router—IP flag. The router IP flag is set to one, iff IPx is one of the router IP addresses. The firmware 108 looks up IPx in the buckets for resolution pending structures. If some packets destined to IPx are pending for resolution, the firmware 108 will route them one by one. The firmware 108 will also update the ARP mapping accordingly, in the corresponding next_hop_router/arp_mapping structure, if it exists.

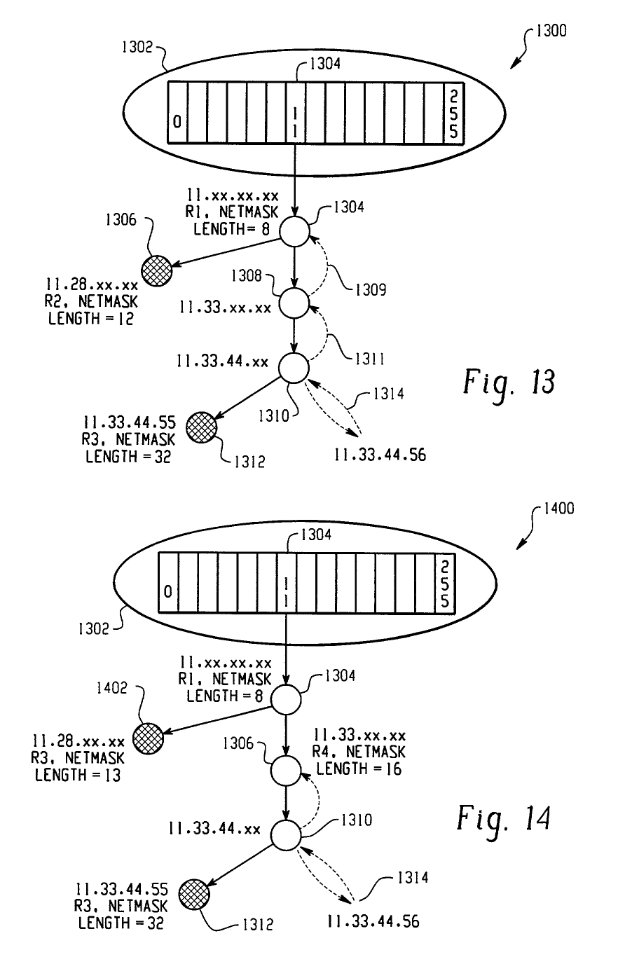

Referring now to FIG. 13, there is illustrated a second example of the creation of a routing tree 1300. Suppose, for example, that the routing table in the routing database 104 contains the following routing table entries: 11 . xx.xx.xx routes to R1; 11.2x.xx.xx routes to R2 (i.e., a netmask of 12); 11.33.44.55 routes to R3; and default routes to Rd_{def}.

Beginning from an initialized state, and after receiving a first packet destined to a first address 11.28.33.44, the firmware 108 visits the root node 1302 and finds that a 0×11 child 1304 has a pseudo_child bit=0, and 11 th child pointer=NULL. The firmware 108 then sends a Route Request message to the software manager 103, in response to which the software manager 103 sends a Route Response message back to the firmware 108 with information sufficient to generate a first child node 1304 (11.xx.xx.xx.xx for R1, and a netmask length=8). The first child node 1304 is generated in the cached routing tree 1300 of the cache memory 116, having a first leaf node 1306 (11.28.xx.xx for R2, and a netmask length=12).

After receiving a second packet destined to a second address 11.33.44.55, the firmware 108 visits the first child node 1304 and determines that the 0x33 child has a pointer that is NULL. With repeated requests to the software manager 103, the firmware 108 then sends a Route Request message to the software manager 103, in response to which the software manager 103 sends Route Response messages back to the firmware 108 with information sufficient to generate a second child node 1308 (11.33.xx.xx), a third child node 1310 (11.33.44.xx xx ), with the third child node 1310 having a second leaf node 1312 (11.33.44.55 for R3, and a netmask—32). Note that the second child node 1308 has a backtrack pointer 1309 (denoted as a dotted line) to the first child node 1304, and the third child node 1310 has a backtrack pointer 1311 (denoted as a dotted line) to the second child node 1308.

After receiving a third packet destined to a third address 11.33.44.56, the firmware 108 visits the third child node 1310 and determines that the 0x 56 child has a pointer that is NULL. The firmware 108 then sends a Route Request message to the software manager 103, in response to which the software manager 103 sends a Route Response message back to the firmware 108 with information sufficient to generate a first pseudo child node 1314 (11.33.44.56).

Referring now to FIG. 14, there is illustrated an updated cached routing tree 1400 that includes an updated leaf node 1402 that replaces the leaf node 1306 of the routing tree 1300 of FIG. 13. Now, instead of in the previous examples where the firmware 108 requested information from a “fixed” routing table in the routing database 104, a new route 11.21bbb.xx.xx that routes to R3 is created in the routing table of the software database 104 after the routing tree has been established to some extent. Here, after the routing table has been updated with the new route information, the software manager 103 sends a Route Add message to the firmware 108 with the information<11.21bbb.xx.xx, R3, netmask length=13, flags=0>. The firmware 108 checks against the first leaf node 1306 (11.28.xx.xx) of FIG. 13, and on up, i.e., node (11.29.xx.xx), . . . , node (11.28.xx.xx). If any of these nodes exist, the firmware 108 compares the netmask length of 12 in the cached routing tree 1300 (of FIG. 13) with new route netmask of 13. In this case, it will find that the netmask length of the first leaf node 1306 (11.28.xx.xx) is smaller than 13 (i.e., it is currently 12). The firmware 108 will update the netmask length of the first leaf node 1306 (11.28.xx.xx) to 13 and route to R3, creating the updated leaf node 1402 of FIG. 14.

Consider that another new route is added in software, such that the address 11.33.xx.xx routes to R4. The software manager 103 will send a Route Add message to the firmware 108 with the information<11.33.xx.xx, R4, netmask length=16, flags=0>. The firmware 108 then updates the second child node 1308 (11.33.xx.xx) route to R4 and netmask length to 16. The firmware 108 also sets the second child node 1308 backtrack flag to 0, effectively eliminating the illustration of the backtrack pointer 1309 of FIG. 13.

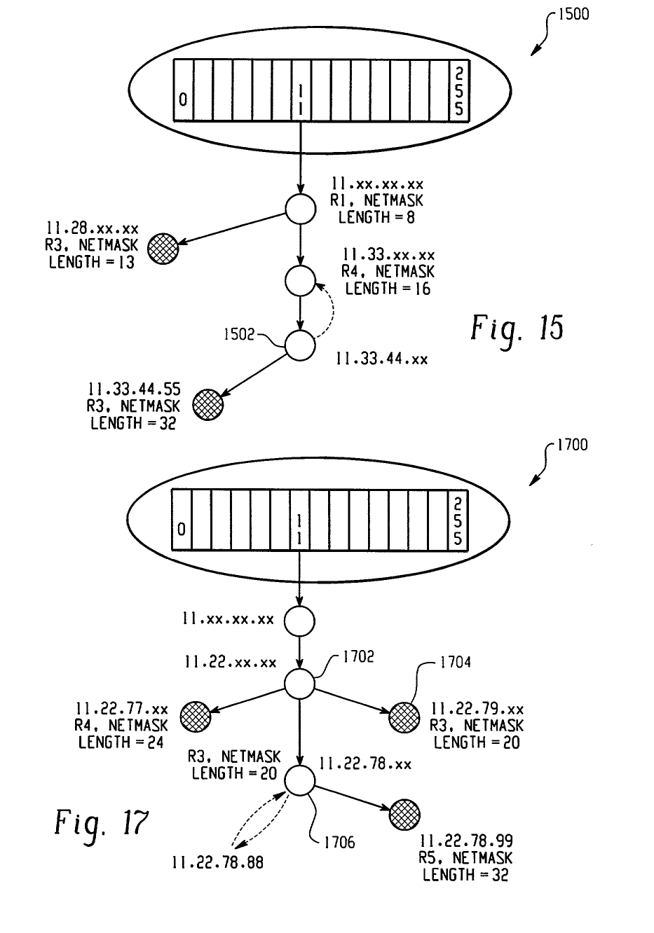

Referring now to FIG. 15, there is illustrated an updated routing tree 1500 from the example of FIG. 14. Consider another new route is created in the routing database 104, where 11.33.44.5xx routes to R5. The software manager 103 then sends a Route Add message to the firmware 108 with the information<11.33.44.5xx, R5, netmask length=28, flags=0>. The firmware 108 then updates the parameters of the third child node 1310 (11.33.44.xx xx) of FIG. 14 by setting the 56^{th} pseudo child bit to 0 and the 56^{th} child pointer to NULL. This effectively eliminates the illustration of the pseudo child node 1314 of FIG. 13 and FIG. 14, resulting in the updated third child node 1502.

Note that in addition to updating routing nodes when receiving a Route Add message from the software manager 103, the firmware 108 will delete a leaf routing node if the new route is more specific than the existing leaf routing node.

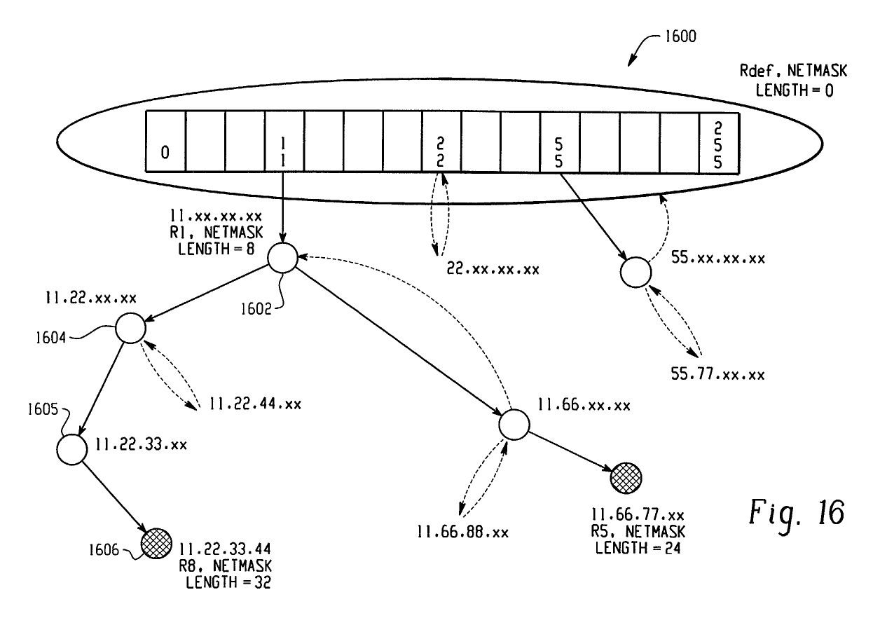

Referring now to FIG. 16, there is illustrated an example routing tree 1600 when the software manager 103 sends two Route Add messages. Considering the current cached routing tree 1200 of FIG. 12, now denoted as updated routing tree 1600, when the software manager 103 sends to the firmware 108, a first Route Add message with the information<11.55.77.xx xx, R7, netmask length=24, flags=0>creating an updated first child node 1602, and a second Route Add message with the information<11.22.33.44, R8, netmask length=32, flags=0>causing an updated second child node 1604. The first Route Add message causes the firmware 108 to update the 55^{th} pseudo_child bit to 0 and the 55^{th} child pointer to NULL of the first child node 1104 (of FIG. 13) becoming the updated first child node 1602, where the pseudo child 1212 (of FIG. 12) is eliminated. The second Route Add message converts the first leaf node 1108 (of FIG. 12) into a fifth child node 1605, and adds a leaf node 1606 now called R8 with a netmask length=32, since, as indicated hereinabove, the updated second child node route 1604 is more specific than the existing first leaf routing node 1108.

Referring now to FIG. 17, there is illustrated a fourth example of creating a cached routing tree 1700 when a table entry is deleted in the routing database 104. Consider that the routing table of the routing database 104 contains the following route entries: 11 .xx.xx.xx routes to R1; 11.22.xx.xx routes to R2; 11.22.7xx.xx routes to R3; 11.22.77.xx routes to R4; 11.22.78.99 routes to R5; and the default routes to the default router Rdef . After a first packet destined to address 11.22.77.88, a second packet destined to address 11.22.78.88, a third packet destined to address 11.22.79.88, and a fourth packet destined to address 11.22.78.99 were received, the cached routing tree 1700 is created in the cache memory 116. The routing tree has, among other nodes, a second child node 1702 from which a second leaf node 1704 extends, and a third child node 1706.

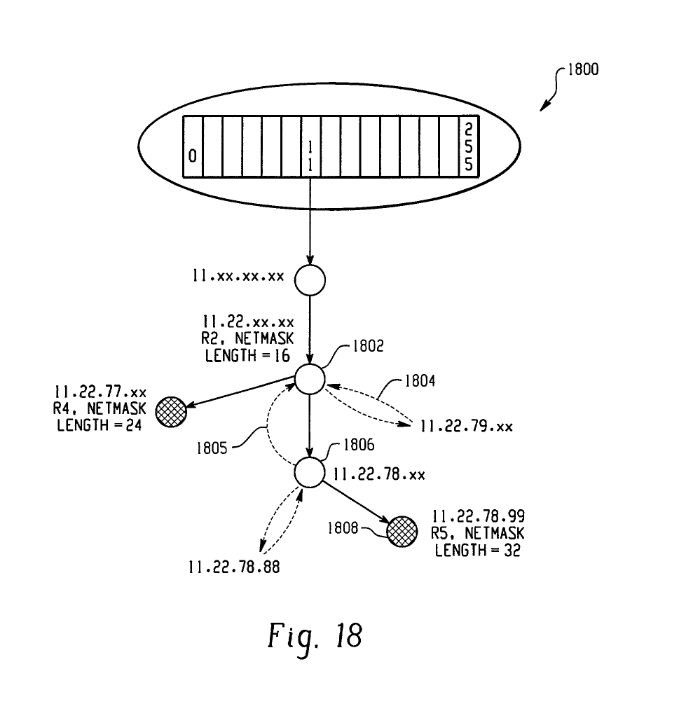

Referring now to FIG. 18, there is illustrated a revised routing tree 1800 in accordance with the deleted routing table entry of FIG. 17. Now consider that the route (11.22.7x.xx, R3, netmask length—20) is deleted. The software manager 103 sends a Route Update message to the firmware 108 with the information<11.22.7x.xx, R3, netmask length =20, DMB=3, R2, new netmask length=16>. The firmware 108 searches for a series of nodes (11.22.70.xx), (11.22.71.xx), . . . , (11.22.7F.xx) with a netmask length=20. For each such node, the node will either be deleted and the corresponding bit in its parent node pseudo_child bitmap set to 1 (if it is a leaf), or its next-hop pointer will be set to NULL and its backtrack flag set to 1. Thus the second child node 1702 is updated to an updated second child node 1802 with the route set to R2 and a netmask length of 16. The second leaf node 1704 is deleted to now become a second pseudo child 1804, in response to changes in the second child node 1702 to the pseudo_child bitmap change to one. The third child node 1706 is updated to an updated third child node 1806 where a backtrack path 1805 to the updated second child node 1802 is created in response to the backtrack flag being set to one. The R3 and netmask length information associated with the third child node 1706 is also now deleted. The values associated with a third leaf node 1808 remain unchanged.

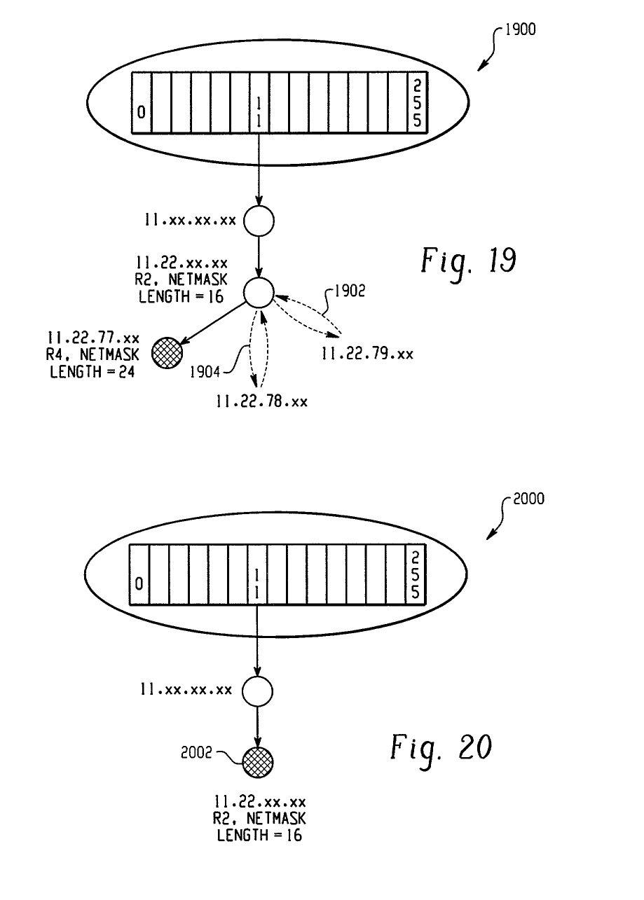

Referring now to FIG. 19, there is illustrated an updated cached routing tree 1900 as a result of further entries being deleted in the routing table of the routing database 104. If the software manager 103 deletes the route entry (11.22.78.99, R5, netmask length=32) associated with the third leaf node 1808 of FIG. 18, a Route Update message is sent to the firmware 108 with the information (11.22.78.99, R5, netmask length=32, DMB=3, R2, new netmask length=16). The firmware 108 deletes the third leaf node 1808 (11.22.78.99) and the third child node 1806 (11.22.78.xx). Thus the third leaf node 1808 transitions to a pseudo child 1902, and the third child node 1806 transitions to a pseudo child 1904.

Referring now to FIG. 20, there is illustrated a revised cached routing tree 2000 where still further table entries are deleted in the routing table of the routing database 104. If the software manager 103 deletes the route (11.22.77.xx R4, netmask length=24), a Route Update message is sent to the firmware 108 having the information (11.22.77.xx, R4, netmask length=24, DMB=2, R2, new netmask length=16>. The firmware 108 deletes the second child node 1802 (11.22.77.xx) of FIG. 18, and sets the leaf flag of the second child node 1802 (11.22.xx.xx) to one, creating a new leaf node 2002.

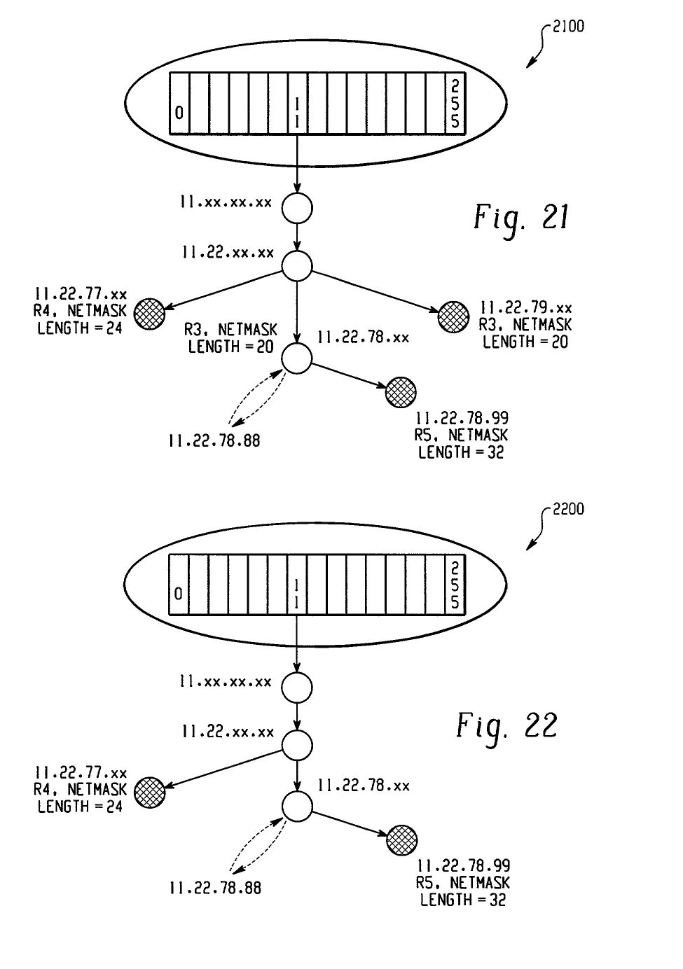

Referring now to FIG. 21, there is illustrated a fifth example of creating a cached routing tree 2100 when a table entry is deleted in the routing database 104. Consider that the routing table of the routing database 104 contains the following route entries: 11.xx.xx.xx routes to R1; 11.22.xx.xx routes to R2; 11.22.011b bbbb.xx routes to R6; 11.22.7x.xx routes to R3; 11.22.77.xx routes to R4; 11.22.78.99 routes to R5; and default routes to the default router R_{def}. After a first packet destined to a first address 11.22.77.88, a second packet destined to a second address 11.22.78.88, a third packet destined to third address 11.22.79.88, and a fourth packet destined to fourth address 11.22.78.99 were received, the cached routing tree 2100 is created in the cache memory 116.

Referring now to FIG. 22, there is illustrated an updated routing tree 2200 of the tree 2100 of FIG. 21, when a table entry is deleted. Now consider that the route (11.22.7x.xx, R3, netmask length=20) is deleted in the routing table of the routing database 104. The software manager 103 sends a Route Update message to the firmware 108 with the information (11.22.7x.xx, R3, netmask length=20, DMB=3, R6, new netmask length=19). The firmware 108 updates generate the updated routing tree 2200.

Note that the firmware 108 maintains an aging list of non-root routing nodes with child count of zero. The firmware 108 starts aging when the percentage of routing nodes in use is greater than or equal to, for example, 90%. Additionally, when the firmware 108 needs to allocate a routing node, and all are in use, the “eldest” route in the aging list will be freed up. When a routing node is freed up due to aging or replacement, the corresponding child pointer in its parent node is set to NULL.

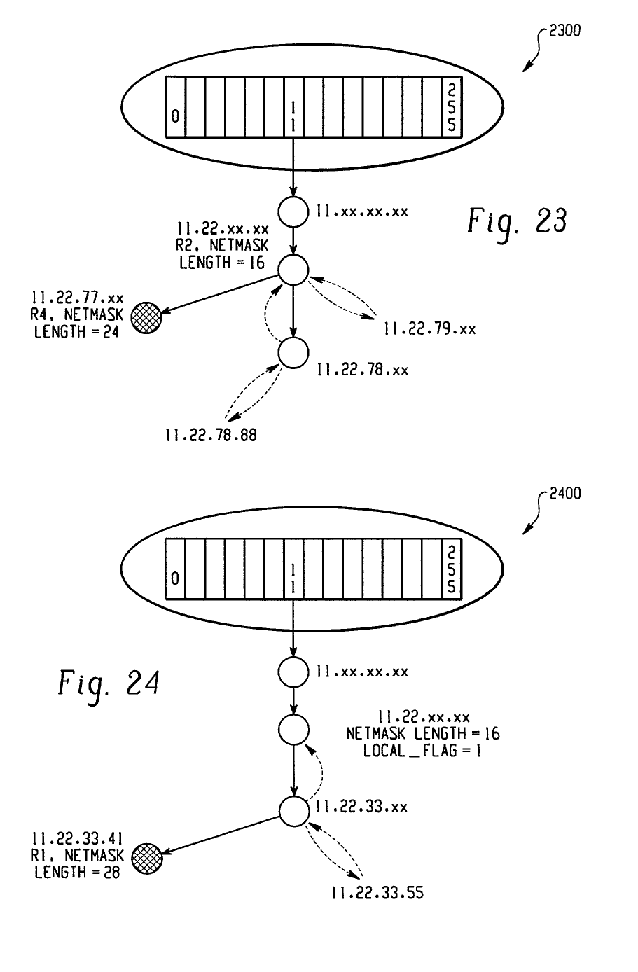

Referring now to FIG. 23, there is illustrated an example of updating a cached routing tree 2300 when a node is aged out. Consider the cached routing tree 1800 of FIG. 18. If the second leaf node 1808 (11.22.78.99) is aged out, then the routing tree 1800 is updated to the updated routing tree 2300, by eliminating the second leaf node 1808 from the routing tree 1800.

Referring now to FIG. 24, there is illustrated an example routing tree 2400 created where a routing table of the routing database 104 includes a directly attached entry. Consider the routing table entries include the following routing entries: 11.22.xx.xx, designated as directly attached; 11.22.33.4x, denoted as R1; and the default router R_{def}. After a first packet destined to first address 11.22.33.41 and a second packet destined to a second address 11.22.33.55 is received, the updated routing tree 2400 is created. Notice that the local _flag of routing node (11.22.xx.xx) is set to 1.

The disclosed architecture can be applied to any network switching device performing hardware- or firmware-based routing. Note also that the implementation can be either in an ASIC (Application Specific Integrated Circuit) design or network processor-based design.

Although the preferred embodiment has been described in detail, it should be understood that various changes, substitutions and alterations could be made therein without departing from the spirit and scope of the invention as defined by the appended claims.

What is claimed is:

1. A method of processing routing information in a data network, comprising the steps of:
providing a set of routing information entries in a routing database of a first storage location;
creating a subset of the routing information entries in a second storage location; and
accessing the second storage location before the first storage location when a packet is received.

2. The method of claim 1, wherein the time to access the second storage location is less than the time to access the first storage location.

3. The method of claim 1, wherein the second storage location is a cache memory associated with a network switching device, and the first storage location is network computing device that includes a storage device on which the routing database is stored.

4. The method of claim 1, further comprising the step of updating the subset of routing information entries of the second storage location when at least one of, the packet is received that includes routing information not contained in the subset of routing information entries, one of the set of routing information entries of the first storage location is deleted, a new routing information entry is added to the set of routing information entries of the first storage location, and a select one of the subset of the set of routing information entries of the second storage location is aged out.

5. The method of claim 1, wherein the second storage location is associated with a network switching device, which network switching device includes an interface algorithm that interfaces to the first storage location to receive routing information therefrom, and which interface algorithm further interfaces to a search engine of the network switching device to communicate results of the step of accessing from the search engine to the first storage location and maintains the subset of routing information entries of the second storage location.

6. The method of claim 5, wherein the interface algorithm resides in firmware of the network switching device.

7. The method of claim 1, wherein the subset of routing information entries in the second storage location is structured as an IP tree.

8. The method of claim 1, wherein the routing information is processed by a resolving algorithm that resolves an IP address, which algorithm includes no more than four layers of direct-addressed pointer tables.

9. The method of claim 1, further comprising the steps of,
extracting a destination address of the packet, which destination address contains multiple bytes, and
resolving the destination address by comparing at least one of the multiple bytes with a respective pointer table.

10. The method of claim 9, wherein the multiple bytes are compared sequentially to respective pointer tables in the subset of routing information of the second storage location until the routing information for the packet is detected.

11. The method of claim 10, wherein the step of resolving further includes the step of backtracking to a previous pointer table associated with a previous byte of the multiple bytes to retrieve control information.

12. The method of claim 1, further comprising the step of enqueing the packet in order to access the first storage location when the routing information is not found in the step of accessing the second storage location.

13. The method of claim 1, wherein the subset of routing information in the step of creating is adjusted dynamically in response to the availability of packet routing information of the packet in the subset of routing information.

14. The method of claim 1, wherein the first storage location communicates with a third storage location to update the routing information of the routing database in the step of providing.

15. A method of processing routing information in a data network, comprising the steps of:
providing a set of routing information entries in a routing database of a first storage location;
creating a subset of the routing information entries in a second storage location;
accessing the second location before the first location when a packet is received; and
adjusting dynamically the subset of routing information in response to the availability of packet routing information of the packet in the subset of routing information.

16. The method of claim 15, further comprising the step of resolving a multi-byte destination address of the packet against the subset of routing information with a resolving algorithm, which resolving algorithm includes no more than four layers of direct addressed pointer tables, each layer associated with a byte of the destination address.

17. The method of claim 16, wherein the step of resolving further includes the step of backtracking to a previous pointer table associated with a previous byte of the destination address multiple bytes to retrieve control information.

18. A method of processing routing information in a data network, comprising the steps of:
providing a set of routing information entries in a routing database of a first storage location;
creating a subset of the routing information entries in a second storage location, which subset of the routing information entries are in the structure of an IP tree;
extracting packet routing information of an incoming packet, which packet routing information includes multiple byte parts;
accessing the second storage location to compare the multiple byte parts of the packet routing information sequentially with respective entries of the subset of routing information entries to determine forwarding information; and
adjusting dynamically the subset of routing information in response to the availability of the packet routing information in the subset of routing information entries.

19. A system of processing routing information in a data network, comprising:
a set of routing information entries provided in a routing database of a first storage location; and
a subset of the routing information entries created in a second storage location;
wherein the second storage location is accessed before the first storage location when a packet is received.

20. The system of claim 19, wherein the time to access the second storage location is less than the time to access the first storage location.

21. The system of claim 19, wherein the second storage location is a cache memory associated with a network switching device, and the first storage location is network computing device that includes a storage device on which the routing database is stored.

22. The system of claim 19, wherein the subset of routing information entries of the second storage location is updated when at least one of, the packet is received that includes routing information not contained in the subset of routing information entries, one of the set of routing information entries of the first storage location is deleted, a new routing information entry is added to the set of routing information entries of the first storage location, and a select one of the subset of the set of routing information entries of the second storage location is aged out.

23. The system of claim 19, wherein the second storage location is associated with a network switching device, which network switching device includes an interface algorithm that interfaces to the first storage location to receive routing information therefrom, and which interface algorithm further interfaces to a search engine of the network switching device to communicate results from the search engine to the first storage location and maintains the subset of routing information entries of the second storage location.

24. The system of claim 23, wherein the interface algorithm resides in firmware of the network switching device.

25. The system of claim 19, wherein the subset of routing information entries in the second storage location is structured as an IP tree.

26. The system of claim 19, wherein the routing information is processed by a resolving algorithm that resolves an IP address, which algorithm includes no more than four layers of direct-addressed pointer tables.

27. The system of claim 19, wherein a destination address is extracted from the packet, which destination address contains multiple bytes, and the destination address is resolved by comparing at least one of the multiple bytes with a respective pointer table.

28. The system of claim 27, wherein the multiple bytes are compared sequentially to respective pointer tables in the subset of routing information of the second storage location until the routing information for the packet is detected.

29. The system of claim 28, wherein the destination address is resolved by backtracking to a previous pointer table associated with a previous byte of the multiple bytes to retrieve control information.

30. The system of claim 19, wherein the packet is enqueued in order to access the first storage location when the routing information is not found in the second storage location.

31. The system of claim 19, wherein the subset of routing information is adjusted dynamically in response to the availability of packet routing information of the packet in the subset of routing information.

32. The system of claim 19, wherein the first storage location communicates with a third storage location to update the routing information entries of the routing database.

33. A system of processing routing information in a data network, comprising:
a set of routing information entries stored in a routing database of a first storage location; and
a subset of the routing information entries created in a second storage location;
wherein the second location is accessed before the first location when a packet is received;
wherein the subset of routing information is adjusted dynamically in response to the availability of packet routing information of the packet in the subset of routing information.

34. The system of claim 33, wherein a multi-byte destination address of the packet is resolved against the subset of routing information entries with a resolving algorithm, which resolving algorithm includes no more than four layers of direct-addressed pointer tables, each layer associated with a byte of the destination address.

35. The system of claim 34, wherein the destination address is resolved by backtracking to a previous pointer table associated with a previous byte of the multiple bytes to retrieve control information.

36. The system of claim 33, wherein the second storage location is associated with a network switching device, which network switching device includes an interface algorithm that interfaces to the first storage location to receive routing information therefrom, and which interface algorithm further interfaces to a search engine of the network switching device to communicate results from the search engine to the first storage location and maintains the subset of routing information entries of the second storage location.

37. A system of processing routing information in a data network, comprising:
a set of routing information entries in a routing database of a first storage location;
a subset of the routing information entries created in a second storage location, which subset of the routing information entries are in the structure of an IP tree;
wherein packet routing information is extracted from an incoming packet, which packet routing information includes multiple byte parts;
wherein the second storage location is accessed to compare the multiple byte parts of the packet routing information sequentially with respective entries of the subset of routing information entries to determine forwarding information; and
wherein the subset of routing information is adjusted dynamically in response to the availability of the packet routing information in the subset of routing information entries.

38. The system of claim 37, wherein the second storage location is associated with a network switching device, which network switching device includes an interface algorithm that interfaces to the first storage location to receive routing information therefrom, and which interface algorithm further interfaces to a search engine of the network switching device to communicate results from the search engine to the first storage location and maintains the subset of routing information entries of the second storage location.

39. A system of processing routing information in a data network, comprising:
a first storage location of a network for storing a set of routing information; and
a second storage location for storing a subset of the routing information, which second storage location is associated with a network switching device, which network switching device includes,
a search engine for extracting a destination address of an incoming packet, and resolving the destination address against the subset of routing information of the second storage location; and
an interface algorithm for interfacing with the first storage location to facilitate dynamic adjustment of the subset of routing information entries at the second storage location based upon the availability destination information associated with the packet in the subset of routing information.
